(19) United States
(12) Patent Application Publication
(10) Pub. No.: US 2025/0374124 A1
(43) Pub. Date: Dec. 4, 2025

(54) FACILITATING HIERARCHICAL NETWORK CONTROL FOR LOAD-BALANCED NETWORK ENERGY SAVINGS IN ADVANCED COMMUNICATION NETWORKS

(71) Applicant: Dell Products, L.P., Round Rock, TX (US)

(72) Inventors: Jeebak Mitra, Ottawa (CA); Javad Mirzaei, Toronto (CA); Gwenael Poitau, Montreal (CA)

(21) Appl. No.: 18/678,842

(22) Filed: May 30, 2024

(51) Int. Cl. H04W 28/08; H04W 24/02; H04W 28/086

(52) U.S. Cl. CPC H04W 28/0917; H04W 24/02; H04W 28/0861

(57) ABSTRACT

Facilitating hierarchical network control for load-balanced network energy savings in advanced communication networks is discussed. A method includes based on a federated learning process, determining, by a system comprising at least one processor, a graphical representation of a communication network. The graphical representation identifies respective communications between a group of radio units and a radio access network intelligent controller. The method also includes, based on the graphical representation, facilitating, by the system, user equipment association that defines an action for a network traffic load balancing process according to a network energy savings criterion. The network traffic load balancing process transfers network traffic of a specified user equipment from a source cell of a group of cells of the communication network to a target cell of the group of cells.

### BACKGROUND

The use of computing devices is ubiquitous. Given the explosive demand placed upon mobile networks and the advent of advanced use cases (e.g., streaming, gaming, and so on), power consumption in such networks is higher as compared to previous generations including Long Term Evolution (LTE) networks, for example. Such power consumption can be attributed to the exponential increase in the network data flowing through the advanced network and the need for faster processing of complex tasks to enable the high data rates. Accordingly, unique challenges related to network efficiency exist and in view of forthcoming deployments of Fifth Generation (5G), new radio (NR), Sixth Generation (6G), or other next generation, standards for network communication.

The above-described context with respect to communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes, based on a federated learning process, determining, by a system comprising at least one processor, a graphical representation of a communication network. The graphical representation identifies respective communications between a group of radio units and a radio access network intelligent controller. The method also includes, based on the graphical representation, facilitating, by the system, user equipment association that defines an action for a network traffic load balancing process according to a network energy savings criterion. The network traffic load balancing process transfers network traffic of a specified user equipment from a source cell of a group of cells of the communication network to a target cell of the group of cells.

In an implementation, the graphical representation is a first graphical representation and the method can include determining, by the system, a second graphical representation of a radio unit level of the communication network. The method can also include, based on information indicative of the second graphical representation of the communication network, determining the first graphical representation, wherein the first graphical representation is associated with a radio access network intelligence controller level of the communication network.

In an example, the second graphical representation is an original graph of the communication network, and the first graphical representation is a supergraph derived from the original graph. According to another example, the information indicative of the second graphical representation comprises weighted values that represent communication links between radio units to radio access network intelligent controllers.

The method can include, according to some implementations, prior to the determining of the graphical representation of the communication network, performing, by the system, the federated learning process. The federated learning process can include training, by the system, a first model to a first defined confidence level. Training of the first model can include performing localized processing at a radio unit level of the communication network. Further the federated learning process can include sending, by the system, information indicative of weighted values associated with the first model from the radio unit level to a radio access network intelligence controller level of the communication network. In addition, the federated learning process can include training, by the system, a second model to a second defined confidence level. Training of the second model can include performing pooled processing at the radio access network intelligence controller level of the communication network.

In accordance with the above implementations, user data associated with the user equipment is not included in the information indicative of the weighted values. Further, in accordance with the above implementations, the first model and the second model are graph neural network models. Alternatively, or additionally, the first model and the second model are message passing graph neural network models. Further, the group of cells can be configured to operate according to a fifth generation radio network communication protocol.

Another embodiment relates to a system that includes at least one processor and at least one memory that stores executable instructions that, when executed by the at least one processor, facilitate performance of operations. The operations can include performing a network traffic load balancing procedure according to an energy savings criterion. The network traffic load balancing procedure transfers network traffic of a user equipment from a source cell to a specified target cell within a cellular communication network. Performing the network traffic load balancing procedure can include, based on information indicative of a first graphical construct that represents a radio unit level of the cellular communication network, determining a second graphical construct that represents a radio access network intelligence controller level of the cellular communication network. Performing the network traffic load balancing procedure can also include, based on the second graphical construct of the cellular communication network, transferring the network traffic of the user equipment from the source cell to the specified target cell.

The information indicative of the first graphical construct can include weighted values that represent communication links between radio units of the radio unit level of the cellular communication network to radio access network intelligent controllers of the radio access network intelligence controller level of the cellular communication network.

According to some implementations, the operations can include, prior to performing the network traffic load balancing procedure, training a machine learning model to a defined confidence level. For example, the machine learning model can be a graph neural network model.

The operations can include, according to some implementations, prior to performing the network traffic load balancing procedure, performing a federated learning process. The federated learning process can include training a first model to a first defined confidence level. Training of the first model can include performing localized processing at a radio unit level of the cellular communication network. Training of the first model can also include, based on information indicative of weighted values associated with the first model, training a second model to a second defined confidence level. The training of the second model can include performing pooled processing at a radio access network intelligence controller level of the cellular communication network. According to an example, training of the second model can include training the second model to facilitate conformance with a network energy savings minimization criterion.

Yet another embodiment relates to a non-transitory machine-readable medium, comprising executable instructions that, when executed by a processor of network equipment, facilitate performance of operations. The operations can include, based on a federated learning process, determining a graphical representation of a communication network. The graphical representation identifies respective communications between a group of radio units and a radio access network intelligent controller. The operations can also include, based on the graphical representation, performing user equipment association that facilitates conformance to an energy savings criterion. The network traffic load balancing process defines an action for a network traffic load balancing process that transfers a defined user equipment from being connected to a source cell of a group of cells of the communication network to being connected to a target cell of the group of cells.

According to an implementation, the operations can include, prior to determining of the graphical representation of the communication network, training a first model to a first defined confidence level. The training of the first model can include performing localized processing at a radio unit level of the communication network. The operations can also include, based on information indicative of weighted values associated with the first model, training a second model to a second defined confidence level. Training of the second model can include performing pooled processing at a radio access network intelligence controller level of the communication network. In an example, the weighted values are non-zero weights that represent respective connectivities between the group of radio units and the radio access network intelligent controller.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, cellular wireless network that comprises randomly distributed user equipment and tri-sector antennas in accordance with one or more embodiments;

FIGS. 2A and 2B illustrate the example, non-limiting, cellular wireless network of FIG. 1 where network energy savings inspired load balancing has been applied in the network cluster in accordance with one or more embodiments described herein;

FIGS. 3A and 3B illustrate graph-based representations of message flow and aggregation with radio access network intelligencer controllers in accordance with one or more embodiments described herein;

FIG. 4 illustrates an example, non-limiting, system that employs hierarchical federated learning with near-real-time radio intelligent controllers and non-real-time radio intelligent controllers in accordance with one or more embodiments described herein;

FIG. 5 illustrates an example, non-limiting, graphical abstraction of hierarchical network control in accordance with one or more embodiments described herein;

FIGS. 6A-6C illustrate an example, non-limiting, representation of graph based processing in accordance with one or more embodiments described herein;

FIG. 7A illustrates an example, non-limiting, computer-implemented method that facilitates the use of graph neural networks for energy efficient user association in accordance with one or more embodiments described herein;

FIG. 7B illustrates an example, non-limiting, schematic representation of the use of graph neural networks for energy efficient user association in accordance with one or more embodiments described herein;

FIG. 8 illustrates a flow diagram of an example, non-limiting, computer-implemented method that facilitates user association for network energy savings minimization using graph neural networks in accordance with one or more embodiments described herein;

FIG. 9 illustrates a flow diagram of an example, non-limiting, computer-implemented method that facilitates hierarchical network control for load-balanced network energy savings in accordance with one or more embodiments described herein;

FIG. 10 illustrates an example, non-limiting, computing environment in which one or more embodiments described herein can be facilitated;

FIG. 11 illustrates an example, non-limiting, networking environment in which one or more embodiments described herein can be facilitated;

FIG. 12 illustrates a first equation that represents the aggregate power consumption of the network in accordance with one or more embodiments described herein;

FIG. 13 illustrates a second equation that represents the traffic dependent power in accordance with one or more embodiments described herein;

FIG. 14 illustrates a third equation in accordance with one or more embodiments described herein;

FIG. 15 illustrates a fourth equation that minimizes the average network energy consumption in accordance with one or more embodiments described herein;

FIG. 16 illustrates a fifth equation that represents the goal of having the highest carried traffic possible in accordance with one or more embodiments described herein;

FIG. 17 illustrates a sixth equation that defines an adjacency matrix at a radio unit level of a network in accordance with one or more embodiments described herein; and

FIG. 18 illustrates a seventh equation that denotes the received signal reference power measured between nodes of a network in accordance with one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

In conventional cellular networks, the Radio Access Network (RAN) is the major source of energy consumption and can account for about 60% to 80% of the total power consumption in a communications network. With the development of energy efficient radios, different types of energy saving features have been proposed which include use of higher-efficiency power amplifiers (PAs) that can help reduce the power consumption while meeting the targeted Quality of Service (QOS). Additionally, when Base Station (BS) traffic is low, the radios can be operated in a lower power mode since the level of amplification needed is lower. However, most conventional networks follow the strategy of maintaining the BS in a fully operational state even when traffic loads are low, leading to significant energy wastage.

From an energy efficiency perspective, the network resources should be deployed in a load adaptive way as traffic loads of cellular networks show both temporal and spatial variation. For example, one approach could ensure that the BSs are either completely switched off and/or operate in low power consumption modes during periods of negligible traffic to optimize the energy efficiency. It may, however, not always be feasible to completely switch off BSs in the network due to several reasons such as, for example, potentially bursty traffic or the possibility of coverage holes that would render a portion of the user equipment (UE) without any connectivity to the network. This can jeopardize metrics, such as UE QoS that mobile network operators (MNOs) are concerned with in order to retain and increase user subscriptions. Moreover, a BS in a state of hibernation may not be able to transmit signals (such as broadcast information including synchronization signals) needed by the UEs to establish connections.

In cellular networks, the most common metric used for UE association or the selection of a base station (BS) for a UE to connect to is Received Signal Strength Indicator (RSSI) or, when connected, the Reference Signal Received Power (RSRP). The UE tends to associate itself with the BS, with the highest RSSI and/or RSRP. While straightforward, it can be easily determined that this approach can end up being sub-optimal from a global network utilization perspective, as there is a possibility of creating traffic hotspots within the network while other adjacent BSs are not used as much. In fact, despite the highest RSSI, the UE throughput may suffer if the BS is unable to allocate adequate resources to the UE. Equally important for next generation network design is the energy consumption which may not be optimal when certain BSs are overloaded (and therefore forced to use higher energy consuming high throughput transmission configurations) while others are available, yet lightly used. In order to improve network energy savings (NES), often cells that are underutilized can be switched to a lower power consumption mode where they only serve a small number of UEs or are completely switched off if the UEs anchored on the lightly used cells can be re-associated with other active cells. UEs may also be re-associated with other BSs to balance the energy consumption of BSs and allow high traffic BSs to shift to lower power consuming modes opportunistically. However, these decisions are better made when the module making such decisions has full visibility into the network state and more importantly its evolution.

A disaggregated architecture, such as an Open Radio Access Network (O-RAN)) framework allows for the disaggregation of legacy BS functionalities, such that the different BS modules are implemented across multiple RAN modules and/or RAN nodes. Network functions that implement the conventional RAN operations are virtualized and software-based with the interfaces between the different network functions being open and standardized for interoperability. With a software-based approach, to enable algorithmic and programmatic control based on the current network status in order to dynamically configure the network infrastructure, RAN Intelligent Controllers (RICs) can host multiple applications to perform closed-loop control of the RAN using Artificial Intelligence (AI) and/or Machine Learning (ML) techniques. As such, these software-based approaches can be a good platform to implement data-driven solutions for network optimization that can leverage this broader view of the network to learn complex inter-dependencies between RAN parameters and help design policies for the relatively disparate Quality of Service (QOS) requirements of each UE.

Network energy consumption increases in proportion to the throughput requirements and the various enabling techniques, such as wider bandwidth and greater spatial dimensions, that are put in place to enable these throughputs. While energy consumptions of cellular networks have been steadily increasing for the past decade, the issue is considered to be particularly prohibitive for 5G and beyond 5G networks (e.g., advanced networks) due to increased density of deployment and the increased support for multiple antennas, which can range from a few to hundreds of antennas. The various use cases on which the development and deployment of 5G technology is funded often do not need a constant stream of high data rate and, even then, may only need a constant stream of high data rate during certain times of the day. Therefore, a network that is adaptive to varying demands in terms of resource utilization is critically needed in order to avoid wastage and provided with the disclosed embodiments.

Specifically, provided herein are embodiments related to saving network energy consumption by operating certain BSs within a network cluster in low capacity modes when traffic is low and/or if there is a need to re-assign certain UEs to different BSs to lower the overall network energy consumption cost. The latter approach, better known as load balancing, is often carried out to ensure the transmission resource utilization at a given BS does not exceed pre-determined thresholds. However, resource utilization does not serve well as a proxy for total energy consumption and methods to directly address energy consumption minimization are needed, as provided herein. When load balancing is carried out, some UEs associated with high energy consumption BSs are re-associated with alternative neighboring BSs to meet their traffic requirements.

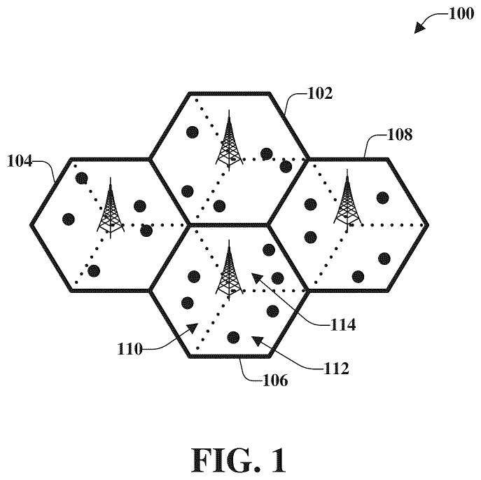

FIG. 1 illustrates an example, non-limiting, cellular wireless network 100 that comprises randomly distributed UEs and tri-sector antennas in accordance with one or more embodiments. For illustration purposes, as depicted in FIG. 1, the cellular wireless network 100 includes a cellular network cluster with four cell sites, labeled as a first cell site 102, a second cell site 104, a third cell site 106, and a fourth cell site 108. Each cell site houses 120 degree coverage isotropic antennas. For example, each cell-site has three antennas (e.g., tri-sector antennas if the antennas are controlled by the same controller). The BSs, via an antenna, cater to the UEs (depicted as the filled circles) in their own 120 degree zone within a hexagonal cell. The tri-sectors are demarcated in each cell site by the dashed lines. For example, the tri-sectors of the third cell site 106 are labeled as a first tri-sector 110, a second tri-sector 112, and a third tri-sector 114. The tri-sectors of the other cell sites are not labeled for purposes of simplicity. The UEs within the interior of each cell connect to the RU that has the highest RSRP (e.g., closest in a radio frequency (RF) signal strength sense), while for those UEs closer to the cell edge, factors beyond RSRP might not be considered. The example deployment topology of FIG. 1 is used to describe both the problem solved by the disclosed embodiments and the solution provided by the disclosed embodiments. A challenge associated with conventional systems is the lack of data driven approaches to NES based load balancing. Strategies to achieve network wide NES by using methods such as cell reselection owing to either complete switch off of certain cell sites or their operation in reduced capacity modes have been considered only very recently. However, these methods have been considered only in a local piecemeal approach that is rules-driven based on heuristic. Therefore, concrete approaches that minimize energy consumption in a network wide manner while meeting traffic demands in a non-disruptive way are under investigation and provided herein. Due to the complexity of the interactions and dependencies, analytical modeling is either hard or deficient in terms of capturing the entire dynamic. Taking advantage of the compute fabric in modern network architectures, data-driven approaches that can be implemented with relatively low complexity are very much needed, and are provided herein. Another challenge associated with conventional systems is the assumption of heterogenous networks (HetNet) with an in-built coverage layer. In such conventional systems, energy efficiency optimization by switching off certain base stations has primarily been considered when there is the existence of an overlay network using Macro base stations (MBS) that are responsible for providing coverage and connectivity to UEs within its coverage area. Simultaneously, there are hotspots where demand for throughput (which can be determined through offline capacity planning exercises) that are serviced by small cell base stations (SBS) within the coverage area of the MBS. A determination of which cell can be switched off then is only restricted to these SBSs being switched off when significant data demand does not exist and the residual demand that may occur if an SBS is switched off can potentially be serviced by the MBS, making it a relatively simpler problem and cannot be easily extended to the more general case where a homogenous set of BSs are deployed.

Yet another challenge associated with conventional systems is that there is no framework for NES-based load balancing with a centralized controller. Wireless networks over the course of operation often end up having a fairly non-uniform distribution of traffic whereby certain BSs carry a higher traffic load compared to other BSs due to the varying distribution of the UEs and the respective demands of the UEs. While a large amount of analysis goes into wireless network planning prior to deploying BSs to determine the inter-site distance (ISD) and the BS capabilities, and so on, there are several factors that may lead to the traffic distribution changing during the day or over extended periods such that the initial deployment ends up being sub-optimal and load balancing based on traffic demand and BS load needs to be performed to improve a fairness index. While doing this from a throughput maximization and/or UE QOS satisfaction has received a fair bit of interest, load balancing for equitable energy consumption across BSs while minimizing a global energy consumption metric has not been considered as much. More importantly, evolved optimization frameworks for the recently proposed disaggregated network architecture with centralized control and compute hubs are still being developed to take advantage of data-driven approaches. Still another challenge associated with conventional systems is the lack of scalable AI/ML based (Artificial Intelligence (AI) and/or Machine Learning (ML)) approaches. Data-driven optimization modules generally require substantial compute capacity for model training and inference and, while this may be challenging for wireless devices, distributed and disaggregated computing platforms can potentially be used for network-based optimization. Moreover, some of the architectures used conventionally for ML, such as multi-layer perceptron (MLP), convolutional neural networks (CNNs) are borrowed from the fields of image processing, computer vision and the like, which do not have a lot of similarity with the time evolution of wireless network behavior. There is, therefore, a need for methods and other embodiments that inherently exploit the wireless network topologies and can scale and be generalizable in large cellular network resource management aspects.

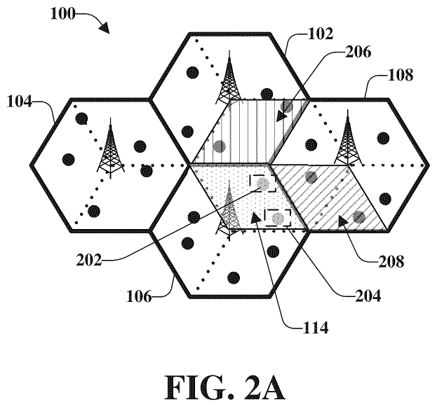

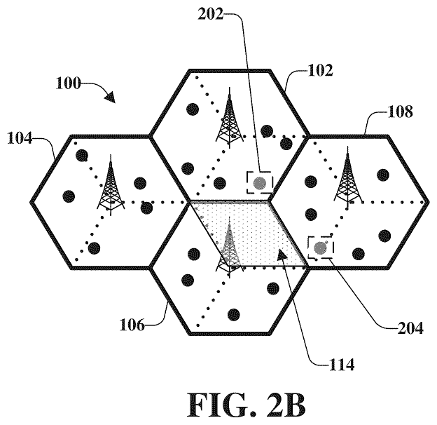

FIGS. 2A and 2B illustrate the example, non-limiting, cellular wireless network 100 of FIG. 1 where NES inspired load balancing has been applied in the network cluster in accordance with one or more embodiments. Repetitive description of like elements employed in other embodiments described herein is omitted for sake of brevity.

The problem of UEs association for NES is depicted in FIGS. 2A and 2B. In FIG. 2A, a cell site with low traffic is identified and, in this example, is the third tri-sector 114 of the third cell site 106. Further, two representative UEs (identified within the dotted squares and labeled as a first defined or specified UE (first UE 202) and a second defined or specified UE (second UE 204)) that are connected to the BS under test (in the third cell site 106) need to be offloaded to neighbor cells prior to this cell (e.g., the third cell site 106) being switched off. Thus the first UE 202 and the second UE 204 are candidate UEs to be migrated for Energy Consumption (EC) reduction. Since the overall traffic demand in this cell (e.g., the third cell site 106) is deemed low, the third cell site 106 can potentially be turned off completely based on an accurate enough traffic prediction regarding the activity of the third cell site 106.

Consequently, neighboring cell sites (illustrated as area 206 of the first cell site 102 and area 208 of the fourth cell site 108) are identified as potential BSs to which the affected UEs (the first UE 202 and the second UE 204) can migrate. The determination of this can become more complex when (a) there are several candidate cells in the neighborhood for the UEs to migrate to and (b) there are several UEs to migrate. In the latter case, the overhead for UE migration may also be a factor to consider from a cost perspective, other than the impact on UE QoS. A policy change is made only when the potential benefits (energy savings) outweigh the costs (e.g., QoS impact, handover costs).

Continuing the above example, FIG. 2B illustrates the result of migration of the candidate users (e.g., the first UE 202, the second UE 204) for EC reduction. As illustrated, the UEs are reassociated with other cell sites. For example, the first UE 202 has been migrated to the first cell site 102 and the second UE 204 has been migrated to the fourth cell site 108. Since the third tri-sector 114 now has no connectivity with any UEs, the cell site (e.g., the third tri-sector 114) can be switched off, which can reduce overall network energy consumption.

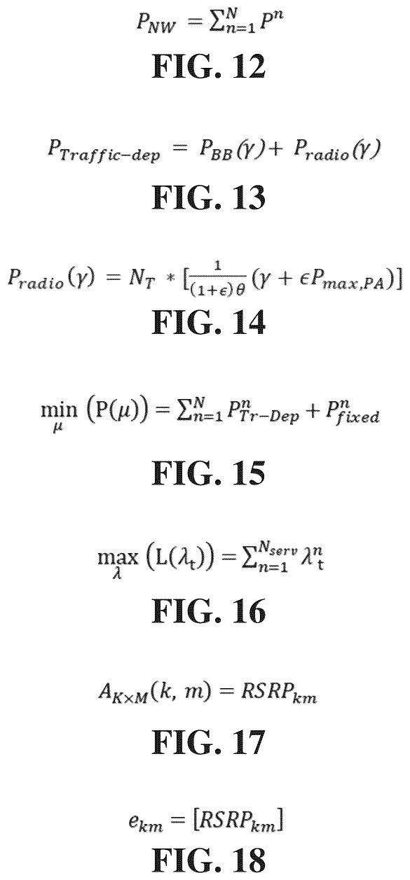

For cell reselection itself, a procedure associated with facilitating generalized cell reselection for network energy savings using graph-based abstractions in advanced communication networks can be readily incorporated with the disclosed embodiments. Details related to the generalized cell reselection for network energy savings using graph-based abstractions will be discussed briefly for the sake of completeness. The objective of that procedure is to associate each user (UE) with a BS that minimizes the overall energy consumption of the network, while maximizing the traffic carried out by the network. In all cases, the minimization of energy consumption takes precedence subject to minimum traffic that is attributed to a guaranteed bit rate (GBR) demand so as to make sure QoS metrics for the traffic classes with the most stringent requirements do not suffer due to the EC minimization objective. Considering a deployment of N Macro BS, the aggregate power consumption of the network is given by the following first equation (Eqn. (1)), also illustrated in FIG. 12, in accordance with one or more embodiments:

$${P}_{NW} = {\sum }_{n = 1}^{N} {P}^{n} \qquad Eqn . ( 1 )$$

with Pₙ=P_{fixed}+P_{Traffic-dep}. Also where P_{fixed} is the fixed power consumption of the BS when carrying no traffic. Strategies proposed herein do not help minimize P_{fixed}, unless the BS is switched off completely and all users connected to that BS (if any) are migrated to a different cell. Additionally, depicted below is a second equation (Eqn. (2)), also illustrated in FIG. 13, in accordance with one or more embodiments:

$${P}_{Traffic - dep} = {P}_{BB} ( γ ) + {P}_{radio} ( γ ) \qquad Eqn . ( 2 )$$

where a third equation (Eqn. (3)), depicted below (also illustrated in FIG. 14), applies:

$${P}_{radio} ( γ ) = {N}_{T} * [ \frac{1}{( 1 + ϵ ) θ} ( γ + ϵ {P}_{max , PA} ) ]$$

where N_{T}, represents the number of active transmit antennas, θ represents a maximum efficiency of a power amplifier (PA), when transmitting max output power ρ_{max,PA} with γ being the load on the PA. Further, P_{BB} denotes the power consumed by the baseband circuitry and ∈ is a parameter that depends on the design of the PA itself.

The average network energy consumption is minimized as per the fourth equation (Eqn. (4)) below, also illustrated in FIG. 15:

$${min}_{μ} ( P ( u ) ) = {\sum }_{n = 1}^{N} {P}_{Tr - Dep}^{n} + {P}_{fixed}^{n} \qquad Eqn . ( 4 )$$

where μ is the policy that leads to the least power consumption by performing load balancing per NES criteria. Within the energy savings objective, the goal is to have highest carried traffic possible, therefore a fifth equation (Eqn. (5)) is derived (also illustrated in FIG. 16).

$${max}_{λ} ( L ( {λ}_{t} ) ) = {\sum }_{n = 1}^{{N}_{serv}} {λ}_{t}^{n} \qquad Eqn . ( 5 )$$

where Nₛₑᵣᵥ is the number of BS that are serving (e.g., 1≤Nₛₑᵣᵥ≤Nₜₒₜ) and Nₜₒₜ is the total number of cells being considered as part of the cluster for NES optimization regardless of its state (e.g., active, idle, switched off). Additionally, L(λ_t) denotes the aggregate traffic load and/or throughput of the network cluster being optimized at the time ‘t’.

In this regard for the avoidance of doubt, any embodiments described herein in the context of optimizing network energy savings are not so limited and should be considered also to cover any techniques that implement underlying aspects or parts of the described aspects to improve or increase network energy savings, even if resulting in a sub-optimal variant obtained by relaxing aspects or parts of a given implementation or embodiment.

The above formulation puts the objective in a min-max (minimum-maximum) formulation and provided below are details related to the approach for solving this objective using Graph Neural Networks (GNNs) in accordance with one or more embodiments.

The optimization policy relies on two sets of actions that may be recommended in order to improve the overall energy consumption of a network cluster. The actions are EC-triggered Load Balancing and Dynamic Cell switch ON and/or OFF (ON/OFF). For the EC-triggered Load balancing, no BSs are switched off. However, a certain set of selected users are migrated to neighboring BSs to improve overall network energy consumption (NEC). According to some implementations, UE re-association is recommended in this case to Layer 3 control modules due to the possibility of achieving a lower energy consumption state for the network.

For the Dynamic Cell switch ON/OFF, BSs with low usage may be switched off. In the case where the BSs with low usage are switched off, all the residual users of those BSs need to be migrated in a way that the overall NES remains optimized for the remaining number of BSs that are on (e.g., in an active state), referring back to FIGS. 2A and 2B.

For the purposes of the various embodiments provided herein, these actions are decided upon by a policy module within a Near-Real Time RAN Intelligent Controller (Near-RT RIC) independently or through explicit support from the global policy module in Non-Real Time RAN Intelligent Controller (Non-RT RIC). From a functional standpoint, such hierarchical decision making allows for assimilation of significantly more data at a global level. However, this also makes the inference slow and, thus, may operate on a time-scale that is different from the policy actions at a near-RT RIC and also with a reduced scope (only for cell sites controlled by a local RIC).

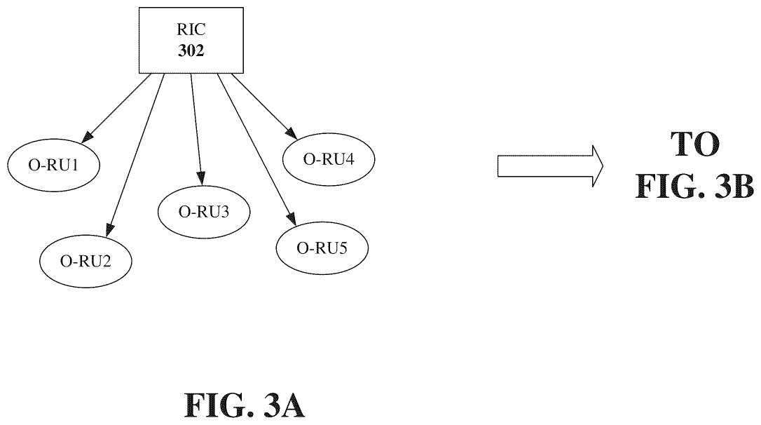

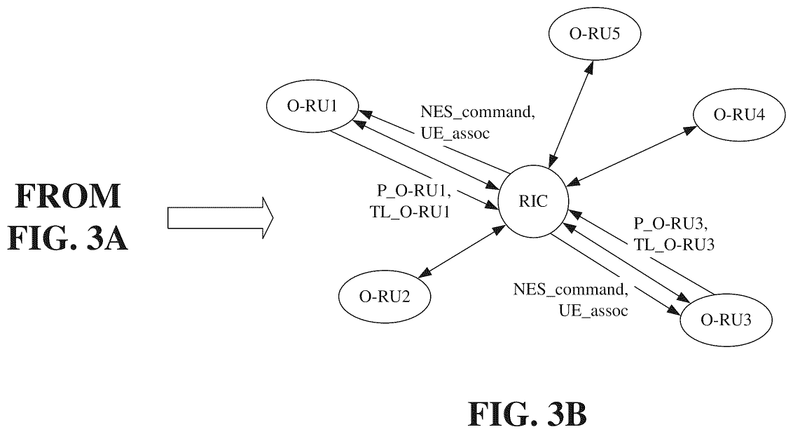

An embodiment provided herein relates to modeling O-RAN RIC control based networks using graphs. The introduction of radio intelligent controllers (RICs) within in the O-RAN framework helps to ensure various network elements work optimally per the network Key Performance Indicators (KPIs) potentially using the collected network data to drive network optimization policy. As provided herein, proposed is the use of graphical networks to model and solve the problem described using neural networks internally for modeling the input-output relationships giving rise to the notion of graphical neural networks (GNNs) to model the wireless communication network dynamics. Graphs are commonly expressed as G=(V, E), where V and E are the sets of nodes and edges, respectively. Furthermore, denoting νᵢ∈V as a node in the graph and eᵢⱼ=(νᵢ, νⱼ)∈E as an edge from node νᵢ to node νⱼ, then eᵢⱼ=1 indicates that νᵢ and νⱼ are connected. When modeling for such a scenario using a graphs G(V, E) the edges in E may be uni-directional as depicted in FIG. 3A, or bi-directional as depicted in FIG. 3B, depending on the flow of information.

For example, FIG. 3A illustrates a RIC 302 that communicates with various Radio Units (RUs), which are depicted as a first RU (O-RU1), a second RU (O-RU2), a third RU (O-RU3), a fourth RU (O-RU4), and a fifth RU (O-RU5). The graph-based representation of message flow and aggregation with RIC control in FIG. 3A is uni-directional. FIG. 3B illustrates a graph-based representation of message flow and aggregation for a bi-directional embodiment. In this case, a RIC 304 and the various RUs are in a bi-directional configuration.

An O-RAN compliant message exchange between the RU and the RIC can occur using M-plane messaging constructs. For example, for the RIC to send NES configuration commands (based on policy derived at RIC) or request measurement data while the RUs can provide periodic measurements or send information regarding internal alarms to the RIC.

At the RU level an adjacency matrix is defined as a sixth equation ((Eqn. (6)) (also illustrated in FIG. 17):

$${A}_{k \times M} ( k , m ) = {RSRRP}_{km} \qquad Eqn . ( 6 )$$

where the seventh equation (Eqn. (7)) below (also depicted in FIG. 18) denotes the RSRP measured between node k and node m:

$${e}_{km} = [ {RSRP}_{km} ] \qquad Eqn . ( 7 )$$

Alternatively, other measurements such as SNR and/or SINR may also be considered instead of RSRP as an edge feature. The RU features that are considered primarily as abstracted graph nodes for NES are the power consumption (Pi) and database that has the relative positions of the RUs and relational table that has the rough uplink and downlink channel quality of the UEs. For the UEs to which the RU is connected, the individual features to consider would be the traffic demand, position, and mobility features such as velocity and direction of travel (away from or towards the RU).

The inputs to the graph based optimization for RU nodes is, therefore, current power consumption and the traffic demand on a per RU basis (e.g., by aggregating them from various UEs connected to a given RU). Note that a connectivity matrix, A is used here, which has dimensions of N×N_{UE} where N denotes the number of RUs that are included in the current cluster and N_{UE} is the total number of UEs served by these N RUs. When an iteration of the optimization algorithm initiates a cell switch or user re-association operation, it is based on the recommended output of the GNN with a different connectivity matrix R′.

Another embodiment relates to Multi-RIC Hierarchical Federated Learning (HFL). Centralized ML training and processing often suffer from two major limitations. A first limitation is the need for formation of training datasets through collection of local data and transporting such locally collected datasets to a central server, which can necessitate huge bandwidth and computation costs. A second limitation is that there are privacy and security concerns with respect to sharing raw datasets with regional clouds as often times the data center may not be used exclusively for one operator.

For these reasons, distributed ML training approaches such as Federated Learning (FL) are gaining popularity. FL is increasingly attractive as it allows the ability to store data locally while pushing network computation to the edge. In an O-RAN context, the main idea of FL is to build learning models through iterative model coordination between one global server and multiple local nodes. As opposed to centralized learning only, it allows the local nodes to keep their raw data private and make optimal use of the local computation power as well as protect user privacy.

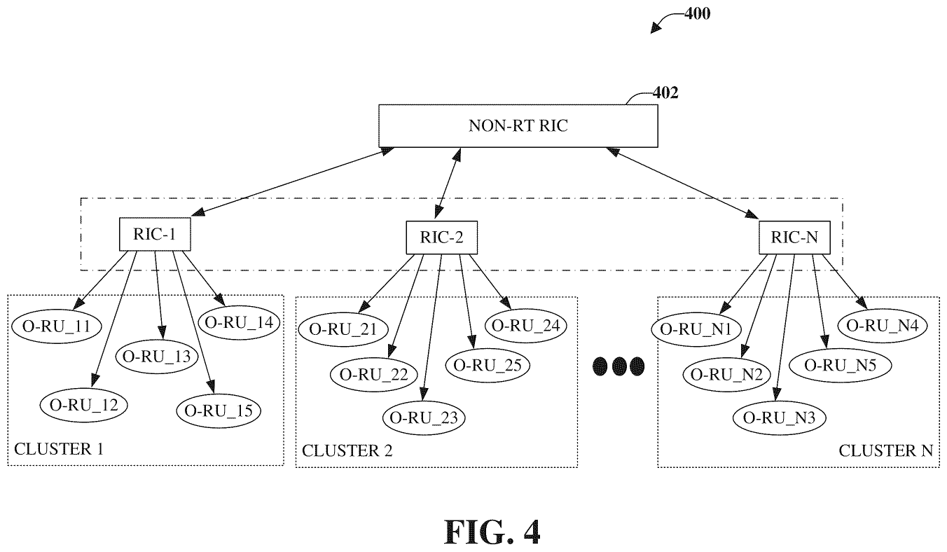

FIG. 4 illustrates an example, non-limiting, system 400 that employs hierarchical federated learning with near-RT RICs and non-RT RICs in accordance with one or more embodiments described herein. Illustrated is a non-RT RIC 402, multiple RICs illustrated collectively at 404, and multiple clusters illustrated collectively at 406. In further detail, illustrated are a first RIC (RIC-1), a second RIC (RIC-2), through an Nth RIC (RIC-N), where N is an integer. Also illustrated are a first cluster (Cluster 1), a second cluster (Cluster 2), through an Nth cluster (Cluster N). The Non-RT RIC 402 can be implemented in the cloud (e.g., a cloud computing environment) with access to (Graphical Processing Unit/High-Performing Clusters) GPU/HPC clusters. The RICs 404 can be implemented on edge servers.

In order to incorporate a generic federated learning framework proposed herein is the use of a hierarchical federated learning approach that allows for the incorporation of both a near-RT RIC and non-RT RIC whereby a global model resides within the non-RT RIC and the model updates are performed as per feedback received from the lower layers with respect to parameters and network behaviors that affect longer term performance metrics while the short-term metric optimization is handled by the near-RT RIC based applications.

Various benefits and advantages can be realized with the multi-RIC hierarchical federal learning embodiments provided herein. For example, by implementing a hierarchical learning approach, the training of the model can be faster and a better communication versus computation trade-off can be achieved. By performing partial model aggregation and training at the edge servers using the time-scale of the near-RT RIC, the model training time as well as total computational effort (and by proxy energy consumption for such training) can both be reduced compared to a cloud-only approach. A global model is maintained by the cloud-based platform, for example, the non-RT RIC and local models are maintained at the edge servers that provide both upstream information to the cloud based non-RT RIC and receive downstream model updates from it. This helps minimize the level of computationally intensive training that needs to be performed at the edge servers.

An example of such computation would be the non-RT RIC extracting the longer-term patterns such as weekly, monthly, or seasonal adjustments while the edge serves providing weights pertinent to diurnal variations, for example. Essentially, such hierarchical architecture as proposed also allows the edge servers to download a global model periodically, perform a faster (multiple-) epoch based local training, and then only transfer the model weights to the cloud server for model aggregation. Since the network conditions are dynamic, training in the above fashion is continued at a pre-described frequency which is higher when the model is just deployed, and the update rate is reduced to an equilibrium rate for a mature model to match with the rate of change of the network topology, and so on.

Further, the disclosed embodiments can achieve model convergence with FL in O-RAN framework. When using data from multiple clusters, convergence of the ML model can take longer than usual and especially for data that is sourced as depicted above. In order to expedite convergence, the RIC may decide to collect data from only a select set of RU clusters that meet a reliability threshold or when communication bandwidth is limited it may use an update schedule that rotates between a set of RUs in a round-robin fashion.

In addition, handovers can be handled with the RIC. In some deployments, the handovers can be handled with only a local view of the network at each RU, however, with the RIC deployed at the edge and cloud level as discussed herein, the modules have a better view of which cells are best for handover without being limited by a small adjacency matrix. This approach therefore is able to minimize the switching costs for UEs better as it is able to choose an alternative RU for a UE to associate with that is globally optimal.

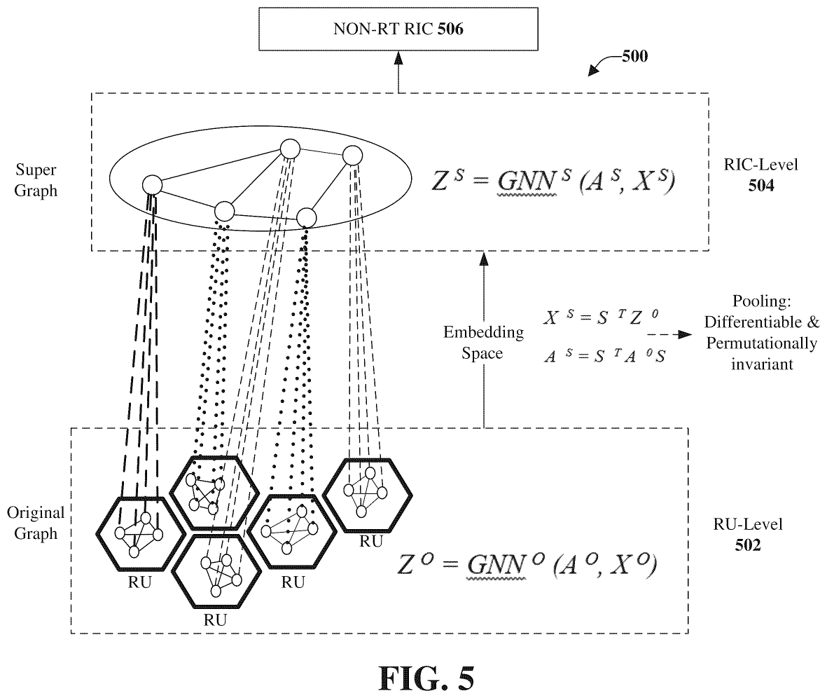

FIG. 5 illustrates an example, non-limiting, graphical abstraction of hierarchical network control in accordance with one or more embodiments described herein. Provided herein is GNN-based learning for optimal NES strategy at the RIC. In some examples, wireless networks are represented as graphs and the ability of graph neural networks (GNNs) to incorporate network constraints in a scalable manner is leveraged to optimize for NES. The benefit of using NN architectures has been the relatively low requirement on domain knowledge in order to provide results that have shown a high level of accuracy over a wide range of unknown distribution. Relatively near-optimal performance is achieved for small-scale wireless networks, but in general they fail to exploit the wireless network structure and therefore may suffer from poor scalability and generalization in large-scale network problems. Accordingly, as discussed herein, the ability of GNNs to be scalable is leveraged to address the user association problem not only at a cluster level but are also able to take global view of the network when the UE migration results in transfer to cells outside the cluster being considered.

A GNN based optimization can be obtained by considering L layers of Message Passing GNN (MPGNN) as shown in FIG. 5 After L layers of processing with MPGNN, the d dimensional features of each node, including UE nodes, is obtained The d dimensional UE nodes feature is fed into the last MLP followed by a SoftMax (or another process or operation) to obtain the N dimensional cell selection vector.

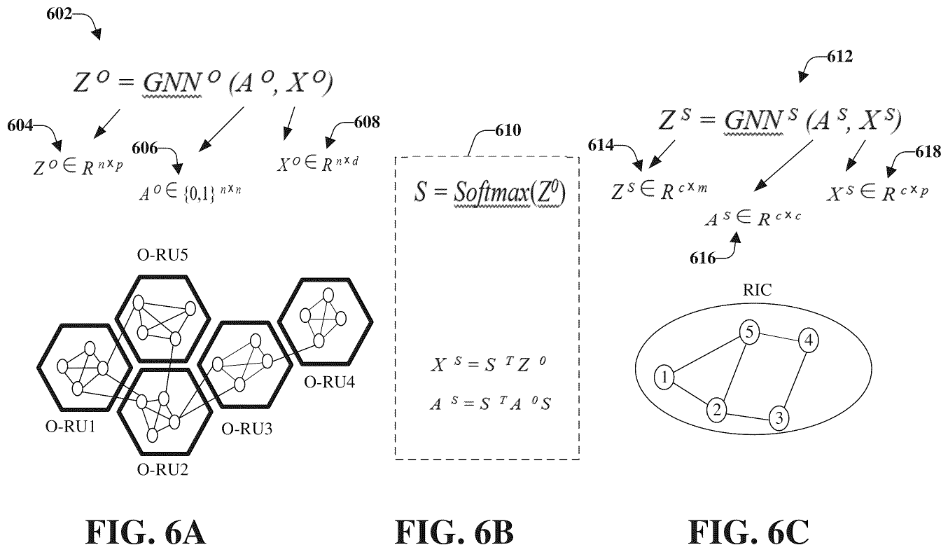

In further detail, illustrated in FIG. 5, at an RU-level 502, are one or more RUs that are in communication with a RIC at a RIC-level 504, which is in communication with a Non-RT RIC 506. The original graph, at the RU-level includes the one or more RUs, which are represented by an eighth equation (Eqn. (8)), also depicted in FIGS. 5 and 6A, where the original graph of FIG. 6A is defined as G^{o} (V^{o}, E^{o}), where V^{o} is the set of vertices and E^{o} is the set edges connecting the vertices in V^{o}:

$${Z}^{O} = {GNN}^{O} ( {A}^{O} , {X}^{O} ) \qquad Eqn . ( 8 )$$

In an embedding space 508, pooling is performed using a ninth equation (Eqn. (9)) and a tenth equation (Eqn. (10)), illustrated below and in FIGS. 5 and 6C can be utilized:

$${X}^{S} = {S}^{T} {Z}^{0} \qquad Eqn . ( 9 )$$

$${A}^{S} = {S}^{T} {A}^{0} S \qquad Eqn . ( 10 )$$

Upon or after the pooling in the embedding space 508, and at the RIC-level 504, an eleventh equation (Eqn. (11), below and in FIGS. 5 and 6C applies:

$${Z}^{S} = {GNN}^{S} ( {A}^{S} , {X}^{s} ) \qquad Eqn . ( 11 )$$

FIGS. 6A-6C illustrate an example, non-limiting, representation of graph based processing in accordance with one or more embodiments described herein. According to an embodiment, end-to-end processing a supergraph approach can be utilized. Using the representation as discussed above with respect to FIG. 5, a method to obtain the optimized NES policy that provides the user association that provides the optimal network energy consumption configuration while meeting the user QoS is provided in FIGS. 6A-6C.

As noted above and depicted in FIG. 6A, the original graph is defined as G^{o} (V^{o}, E^{o}), where V^{o} is the set of vertices and E^{o} is the set edges connecting the vertices in V^{o}. It is assumed that G^{o} has n nodes, where each node may have up to d features. X^{o} and A^{o} denote the feature matrix and adjacency matrix, respectively. After k^{o} iterations of standard GNN processing, Z^{o}, the feature embedding matrix, is obtained, which is then used to find the cell association for each UE.

As indicated at 602 of FIG. 6A, Term1 of Eqn. (8) represents a nodes embedding matrix based on a twelfth equation (Eqn. (12)) indicated below and illustrated at 604 in FIG. 6:

$${Z}^{O} ∈ {R}^{n x p} \qquad Eqn . ( 12 )$$

Term2 of (Eqn. (8)) represents an adjacency matrix based on a thirteenth equation (Eqn.13)) indicated below and illustrated at 606 in FIG. 6.

$${A}^{O} ∈ {\{ 0 , 1 \}}^{n \times n} \qquad Eqn . ( 13 )$$

Term3 of (Eqn. (8)) represents a nodes' feature matrix based on a fourteenth equation (Eqn.14)) indicated below and illustrated at 608 in FIG. 6.

$${X}^{O} ∈ {R}^{n \times d} \qquad Eqn . ( 14 )$$

FIG. 6B represents the equations in SoftMax operation 610 where S=Softmax (Z^{o}) using Eqn. (9) and Eqn. (10). As indicated at 612 of FIG. 6C, Term1 of Eqn. (11) represents a super nodes' embedding matrix based on a fifteenth equation (Eqn. (15)) indicated below and illustrated at 614 in FIG. 6C:

$${Z}^{S} ∈ {R}^{c \times m} \qquad Eqn . ( 15 )$$

Term2 of Eqn. (11) represents an adjacency matrix as represented by a sixteenth equation (Eqn. (16)) as indicated below and illustrated at 616 in FIG. 16:

$${A}^{S} ∈ {R}^{c \times c} \qquad Eqn . ( 16 )$$

Term3 of Eqn. (11) represents a super node's feature matrix as represented by a seventeenth equation (Eqn. (17)) as indicated below and illustrated at 618 in FIG. 16:

$${X}^{S} ∈ {R}^{c \times p} \qquad Eqn . ( 17 )$$

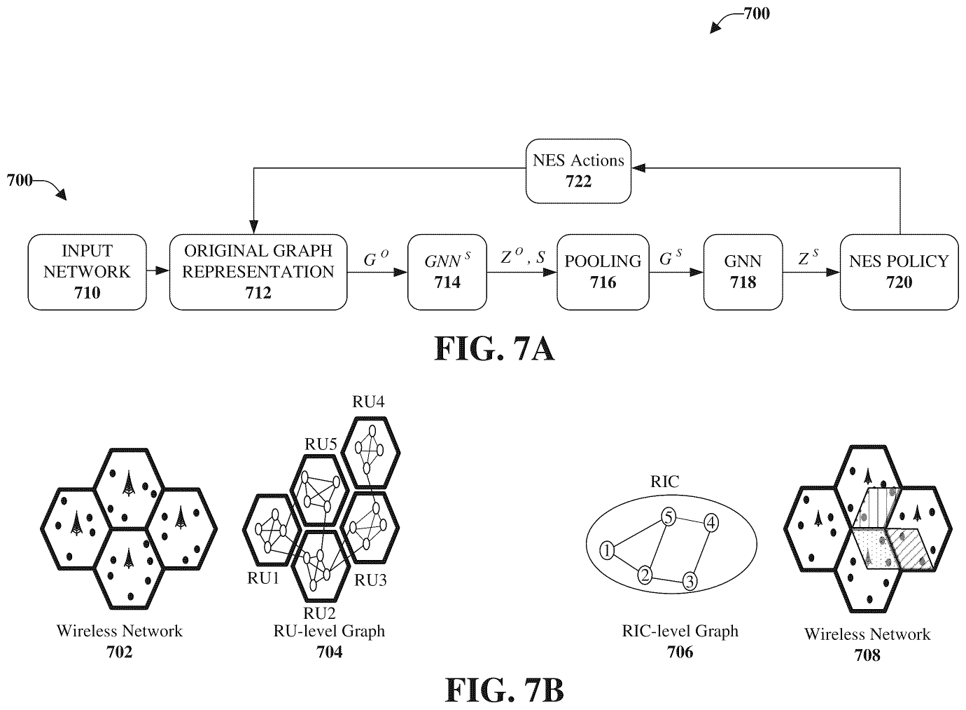

FIG. 7A illustrates an example, non-limiting, computer-implemented method 700 that facilitates the use of GNN for energy efficient user association and FIG. 7B illustrates an example, non-limiting, schematic representation of the use of GNN for energy efficient user association in accordance with one or more embodiments described herein. Repetitive description of like elements employed in other embodiments described herein is omitted for sake of brevity. The computer-implemented method 700 and/or other methods discussed herein can be implemented by network equipment comprising a processor. According to another example, the computer-implemented method can be implemented by a system comprising a processor and a memory.

Provided now is an example of how the disclosed embodiments can be applied to the problem of NES based load balancing in a disaggregated wireless network architectures with centralized network controllers carrying live traffic. Network load rebalancing for higher energy efficiency can be initiated either through a periodic trigger or through monitoring EC levels and initiated through an EC level reaching a range higher than that specified by a network operator. In this regard, FIG. 7A depicts the whole sequence of processing steps that starts with transforming a given network topology to its graphical representation to using such graph rendering to arrive at the optimal user association policy that prioritizes NES.

Illustrated in FIG. 7B are example representations of a wireless network 702 (e.g., the cellular wireless network 100 of FIG. 1A), a RU-level graph 704 (e.g., 602 of FIG. 6), a RIC-level graph 706 (e.g., 612 of FIG. 6), and another wireless network 708 (e.g., the wireless network of FIG. 2A). FIG. 7A depicts cells in a wireless network and one configuration is to consider a tri-sector division of each of the cell such that each cell site comprises three antennas, each antenna covering about 120 degrees. The graph based cell reselection and load balancing for NES can be said to proceed using the following high level steps.

First, the wireless network is defined using its topology and all related configurations, at 710 (input network (Stage 1). The network is then represented in graphical form, at 712 (e.g., G^{o}), with its edges and nodes' features defined as per the network characteristics (Stage 2). The Network graph G^{o} is then provided as input to the pre-trained GNN^{o}, at 714, to obtain the embedding matrix Z^{o} and association matrix S (Stage 3). The RIC-level supergraph G^{S} is then constructed by pooling, at 716, the nodes and their features from the original graph (Stage 4). Network graph G^{S} is then further passed to pre-trained GNN^{S} to determine, at 718, the Super Nodes' embedding matrix Z^{S} corresponding to RIC-level representation (Stage 5). The nodes' embedding matrix Z^{S} is then passed on to the NES policy, at 720, (as described with respect to FIGS. 13-17) for NES specific decisions (Stage 6). Finally, at 722, the NES optimizing policy recommendations are fed back to original graph at the RU level for actuation (Stage 7). It is noted that not all steps of the processing stages of the computer-implemented method 700 depicted in FIG. 7A need to be repeated when the load balancing operation is invoked. For example, processing at 710-714 (e.g., stages 1 through 3) might only be required only when the network is initialized.

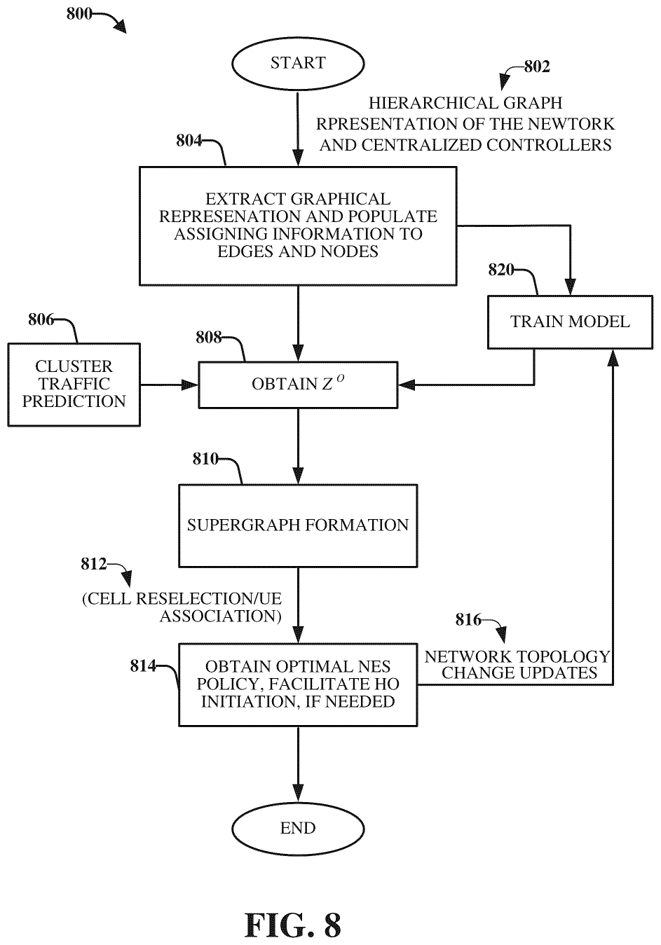

FIG. 8 illustrates a flow diagram of an example, non-limiting, computer-implemented method 800 that facilitates user association for NES minimization using GNNs in accordance with one or more embodiments described herein. The computer-implemented method 800 and/or other methods discussed herein can be implemented by network equipment comprising a processor. According to another example, the computer-implemented method can be implemented by a system comprising a processor and a memory.

Depicted in FIG. 8 are the steps that need to be taken in order to use the methods disclosed herein to achieve optimal user association for NES minimization using a centralized controller such as RIC. The novel supergraph structure enables a federated learning based framework that is seamless in the sense that the edges from the sub-graph layer connecting to supergraph have non-zero weights represent the communication that occurs from RUs to a near-RT RIC that may be collocated with a Distributed Unit (DU) or a non-RT RIC that may be co-located with a Centralized Unit (CU). The communication in each of these cases happens over the open-fronthaul interface that typically uses optical fiber as a medium and thus minimizes chances of errors in providing model feedback for example.

In further detail, the computer-implemented method starts with input data, indicated at 802, which can include hierarchical graph representation of the network and central controllers. Based on the input data, at 804, when one or more graphical representations are extracted from network connectivity information and populate assigning information to edges and nodes. RU nodes features are determined.

At 804, graphical representation can be extracted from network connectivity information. Further, population can be performed by assigning information to edge and nodes. Also RU node features can be determined. At 808 Z^{O} can be obtained. For example, to obtain Z^{O}, extracted graphical representation and other information determined at 804, and cluster traffic prediction 806 can be used as input data. Further, the features matrix X^{O} and the adjacency matrix A^{O} are used to obtain Z^{O}, which can take several iterations.

Upon or after Z^{O} is obtained, supergraph formation can be performed at 810. The supergraph formation can include forming G^{S} (V^{S}, E^{S}) at higher layer from the sub-layer (radio layer) graphs. In addition to the information of a single RU cluster, at the RIC/supergraph layer, the information flow is further extended through exchange of information over edges depicting the logical connectivity between the RIC and various RUs.

As indicated at 814, the output of the GNN processing can be deployed to the network to transition the network to a more optimal state. For example, this can include cell reselection and/or user (UE) association. Further, at 814, the optimal NES policy is obtained and handover (HO) initiation is facilitated, as needed. In further detail, at 814, the optimal Z^{S} can be determined through message passing based optimization amongst the nodes of the supergraph. Further, the optimal NES policy can be determined and passed down to the sub-layer in order to update the user association matrix for HO initiation, if needed, to form a reworked network topology that is NES optimal.

If the network topology changes based on HO initiation, at 814, information indicative of the network topology change updates 816 is input to train a model at 820. Further inputs to train the model at 820 can include the graphical representation and other information determined at 804. Further, training the model at 820 can include, for example, training (or retraining a GNN). For the training, a loss function in terms of network energy consumption can be used. The graph network can be trained to learn the relationships between traffic demand, cell-site load, and power consumption to derive a minimal power consumption policy. This minimal power consumption can be selectively applied to the network.

It is noted that the training might only be carried out periodically after initialization to make sure that the trained network is current. Any non-transitory changes to the topology may also trigger a re-training of the GNN. The retraining can also occur at other times.

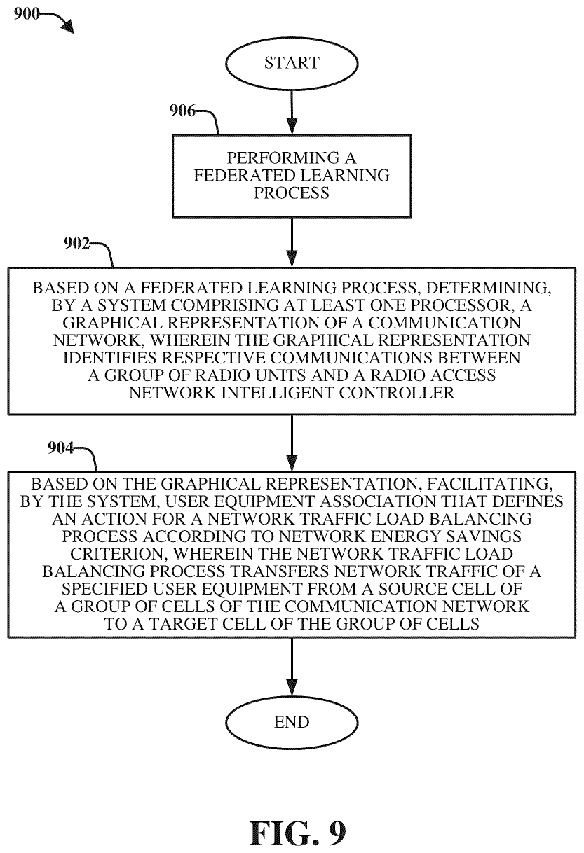

FIG. 9 illustrates a flow diagram of an example, non-limiting, computer-implemented method 900 that facilitates hierarchical network control for load-balanced network energy savings in accordance with one or more embodiments described herein. The computer-implemented method 900 and/or other methods discussed herein can be implemented by network equipment comprising a processor. According to another example, the computer-implemented method can be implemented by a system comprising a processor and a memory.

At 902, based on a federated learning process, the computer-implemented method 900 determines, by a system comprising at least one processor, a graphical representation of a communication network. The graphical representation identifies respective communications between a group of radio units and a radio access network intelligent controller.

Further, at 904, based on the graphical representation, the computer-implemented method 900 facilitates, by the system, user equipment association that defines an action for a network traffic load balancing process according to a network energy savings criteria. The network traffic load balancing process transfers network traffic of a specified user equipment from a source cell of a group of cells of the communication network to a target cell of the group of cells.

For example, the graphical representation can be a first graphical representation. Further, the computer-implemented method 900 can include determining, by the system, a second graphical representation of a radio unit level of the communication network. In this example, the second graphical representation is an original graphical representation of the communication network, and the first graphical representation is a supergraph derived from the original graph. However, it is noted that in some embodiments, the first graphical representation is the original graph of the communion network and the second graphical representation is a supergraph derived from the original graph.

Based on information indicative of the second graphical representation of the communication network, the computer-implemented method 900 can include determining the first graphical representation. The information indicative of the second graphical representation comprises weighted values that represent communication links between radio units to radio access network intelligent controllers. The first graphical representation can be associated with a radio access network intelligence controller level of the communication network.

As illustrated, in some implementations, prior to determining the graphical representation of the communication network, the computer-implemented method 900 can include, at 906, performing the federated learning process. The federated learning process can include training, by the system, a first model to a first defined confidence level. Training of the first model can include performing localized processing at a radio unit level of the communication network. Further, information indicative of weighted values associated with the first model can be sent from the radio unit level to a radio access network intelligence controller level of the communication network. In addition, the federated learning process can include training, by the system, a second model to a second defined confidence level. Training of the second model comprises performing pooled processing at the radio access network intelligence controller level of the communication network.

Further to the above implementation, user data associated with the user equipment is not included in the information indicative of the weighted values. In another example, the first model and the second model are graph neural network models. According to another example, the first model and the second model are message passing graph neural network models. Further, the group of cells is configured to operate according to previous generations of communication protocols (e.g., LTE, fourth generation (4G) communication protocol, and so on), advanced communication protocols, such as a fifth generation (5G) radio network communication protocol, radio network communication protocol, sixth generation (6G) radio network communication protocol, and so on.

As discussed herein, user association plays a critical role in interference management, load balancing, energy consumption and throughput enhancement for wireless networks as it determines the effective load on each serving BS. Conventional methods have relied mostly on signal strength based metrics such as Received Signal Reference Power (RSRP) and the like to determine the cell site that a given UE should associate with. However, this may lead to increased burdens on certain BSs due to high traffic demand in its vicinity and the signal at the UE being relatively stronger from these BSs and can therefore potentially create hotspots. This may consequently lead to increased power consumption at these hotspot BSs as well. While traffic load balancing has been considered and some deterministic optimization based techniques have been proposed, a load balancing approach based on network energy savings (NES) is yet to be considered, and is provided with the disclosed embodiments. Moreover, the optimization techniques used conventionally scale poorly as the network grows since the computational load becomes formidable with more BSs in network cluster. Additionally, conventional methods do not take advantage of the centralized controllers based disaggregated compute architectures (e.g., the use of RICs as introduced in the O-RAN framework), which is provided herein. Therefore, the disclosed embodiments address the issue of balancing energy consumption and improving overall NES in a scalable manner for disaggregated wireless networks.

Provided herein are various embodiments that provide multiple benefits in terms of implementing and deploying a data driven approach to improve the user association of a wireless network to optimize the energy consumption of the network. As discussed, provided is the design of a Federated learning approach that explicitly makes uses of the hierarchical network control framework proposed in O-RAN and leverages the API-based privacy preserving regime to train the network optimization module to achieve energy savings based user association.

Also provided are details related to how edge-based compute and information compression may be used to reduce the amount of overall telemetry traffic that may need to be transferred through a centralized location. This can be used to reduce and/or mitigate both the required communication bandwidth for deriving network intelligence as well as provide timely policy recommendations through this multi-tier architecture.

In addition, provided is an effective means of using GNNs to provide a topology-agnostic computational approach to learn the underlying relationships between the network components with significantly higher generalizability, scalability than conventional approaches.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Example, non-limiting functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU (Central Unit) and O-DU (Distributed Unit) nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) is designed to handle network functions at real time timescales (e.g., a third range of time representing less time than the first time range and the second time range, such as <10 milliseconds).

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

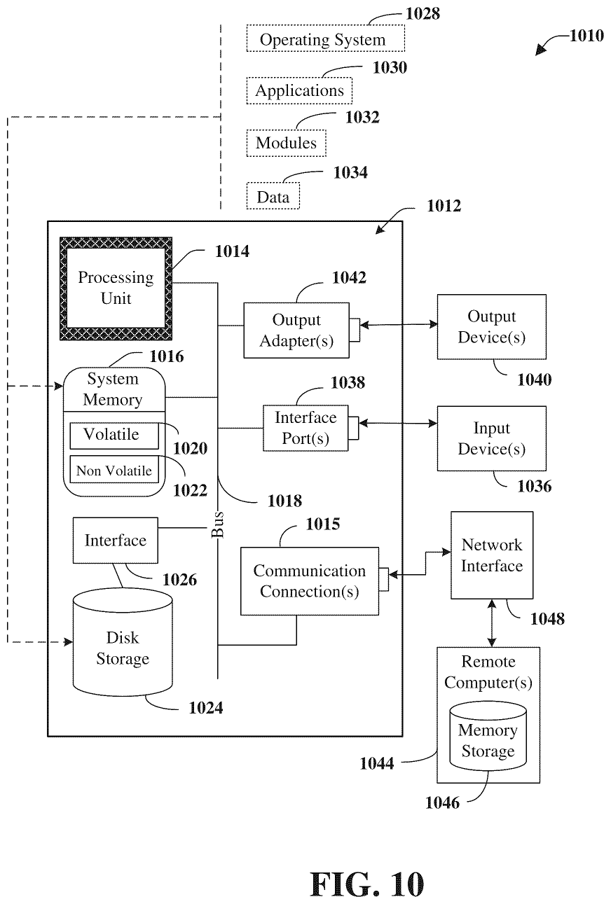

In order to provide a context for the various aspects of the disclosed subject matter, FIG. 10 as well as the following discussion are intended to provide a brief, general description of a suitable environment in which the various aspects of the disclosed subject matter can be implemented.

With reference to FIG. 10, an example environment 1010 for implementing various aspects of the aforementioned subject matter comprises a computer 1012. The computer 1012 comprises a processing unit 1014, a system memory 1016, and a system bus 1018. The system bus 1018 couples system components including, but not limited to, the system memory 1016 to the processing unit 1014. The processing unit 1014 can be any of various available processors. Multi-core microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 comprises volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can comprise read only memory (ROM), programmable ROM (PROM), electrically programmable ROM (EPROM), electrically erasable PROM (EEPROM), or flash memory. Volatile memory 1020 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also comprises removable/non-removable, volatile/non-volatile computer storage media. FIG. 10 illustrates, for example a disk storage 1024. Disk storage 1024 comprises, but is not limited to, devices like a magnetic disk drive, floppy disk drive, tape drive, Jaz drive, Zip drive, LS-100 drive, flash memory card, or memory stick. In addition, disk storage 1024 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software comprises an operating system 1028. Operating system 1028, which can be stored on disk storage 1024, acts to control and allocate resources of the computer 1012. System applications 1030 take advantage of the management of resources by operating system 1028 through program modules 1032 and program data 1034 stored either in system memory 1016 or on disk storage 1024. It is to be appreciated that one or more embodiments of the subject disclosure can be implemented with various operating systems or combinations of operating systems.

A user enters commands or information into the computer 1012 through input device(s) 1036. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 comprise, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapters 1042 are provided to illustrate that there are some output devices 1040 like monitors, speakers, and printers, among other output devices 1040, which require special adapters. The output adapters 1042 comprise, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically comprises many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the system bus 1018. While communication connection 1050 is shown for illustrative clarity inside computer 1012, it can also be external to computer 1012. The hardware/software necessary for connection to the network interface 1048 comprises, for exemplary purposes only, internal, and external technologies such as, modems including regular telephone grade modems, cable modems and DSL modems, ISDN adapters, and Ethernet cards.

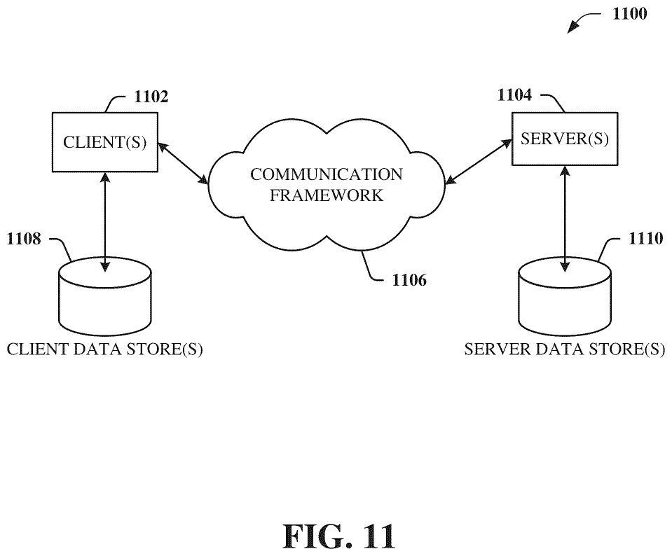

FIG. 11 is a schematic block diagram of a sample computing environment 1100 with which the disclosed subject matter can interact. The sample computing environment 1100 includes one or more client(s) 1102. The client(s) 1102 can be hardware and/or software (e.g., threads, processes, computing devices). The sample computing environment 1100 also includes one or more server(s) 1104. The server(s) 1104 can also be hardware and/or software (e.g., threads, processes, computing devices). The servers 1104 can house threads to perform transformations by employing one or more embodiments as described herein, for example. One possible communication between a client 1102 and servers 1104 can be in the form of a data packet adapted to be transmitted between two or more computer processes. The sample computing environment 1100 includes a communication framework 1106 that can be employed to facilitate communications between the client(s) 1102 and the server(s) 1104. The client(s) 1102 are operably connected to one or more client data store(s) 1108 that can be employed to store information local to the client(s) 1102. Similarly, the server(s) 1104 are operably connected to one or more server data store(s) 1110 that can be employed to store information local to the servers 1104.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGS., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on a federated learning process, determining, by a system comprising at least one processor, a graphical representation of a communication network, wherein the graphical representation identifies respective communications between a group of radio units and a radio access network intelligent controller; and
based on the graphical representation, facilitating, by the system, user equipment association that defines an action for a network traffic load balancing process according to a network energy savings criteria, wherein the network traffic load balancing process transfers network traffic of a specified user equipment from a source cell of a group of cells of the communication network to a target cell of the group of cells.

2. The method of claim 1, wherein the graphical representation is a first graphical representation, and wherein the method further comprises:
determining, by the system, a second graphical representation of a radio unit level of the communication network; and
based on information indicative of the second graphical representation of the communication network, determining the first graphical representation, wherein the first graphical representation is associated with a radio access network intelligence controller level of the communication network.

3. The method of claim 2, wherein the second graphical representation is an original graph of the communication network, and wherein the first graphical representation is a supergraph derived from the original graph.

4. The method of claim 2, wherein the information indicative of the second graphical representation comprises weighted values that represent communication links between radio units to radio access network intelligent controllers.

5. The method of claim 1, further comprising:
prior to determining the graphical representation, performing, by the system, the federated learning process that comprises:
training, by the system, a first model to a first defined confidence level, wherein the training of the first model comprises performing localized processing at a radio unit level of the communication network;
sending, by the system, information indicative of weighted values associated with the first model from the radio unit level to a radio access network intelligence controller level of the communication network; and
training, by the system, a second model to a second defined confidence level, wherein the training of the second model comprises performing pooled processing at the radio access network intelligence controller level of the communication network.

6. The method of claim 5, wherein user data associated with the user equipment is not included in the information indicative of the weighted values.

7. The method of claim 5, wherein the first model and the second model are graph neural network models.

8. The method of claim 7, wherein the first model and the second model are message passing graph neural network models.

9. The method of claim 7, wherein the training of the second model comprises training the second model to facilitate conformance with a network energy savings minimization criterion.

10. A system, comprising:
at least one processor; and
at least one memory that stores executable instructions that, when executed by the at least one processor, facilitate performance of operations, comprising:
performing a network traffic load balancing procedure according to an energy savings criteria, wherein the network traffic load balancing procedure transfers network traffic of a user equipment from a source cell to a specified target cell within a cellular communication network, wherein the performing comprises:
based on information indicative of a first graphical construct that represents a radio unit level of the cellular communication network, determining a second graphical construct that represents a radio access network intelligence controller level of the cellular communication network; and
based on the second graphical construct of the cellular communication network, transferring the network traffic of the user equipment from the source cell to the specified target cell.

11. The system of claim 10, wherein the information indicative of the first graphical construct comprises weighted values that represent communication links between radio units of the radio unit level of the cellular communication network to radio access network intelligent controllers of the radio access network intelligence controller level of the cellular communication network.

12. The system of claim 10, wherein the operations further comprise:
prior to the performing the network traffic load balancing procedure, training a machine learning model to a defined confidence level.

13. The system of claim 12, wherein the machine learning model is a graph neural network model.

14. The system of claim 10, wherein the operations further comprise:
prior to the performing the network traffic load balancing procedure, performing a federated learning process, wherein the federated learning process comprises:
training a first model to a first defined confidence level, wherein the training of the first model comprises performing localized processing at the radio unit level of the cellular communication network; and
based on information indicative of weighted values associated with the first model, training a second model to a second defined confidence level, wherein the training of the second model comprises performing pooled processing at the radio access network intelligence controller level of the cellular communication network.

15. The system of claim 14, wherein the training of the second model comprises training the second model to facilitate conformance with a network energy savings minimization criterion.

16. A non-transitory machine-readable medium, comprising executable instructions that, when executed by at least one processor of network equipment, facilitate performance of operations, wherein the operations comprise:
based on a federated learning process, determining a graphical representation of a communication network, wherein the graphical representation identifies respective communications between a group of radio units and a radio access network intelligent controller; and
based on the graphical representation, performing user equipment association that defines an action for a network traffic load balancing process that facilitates conformance to an energy savings criterion, wherein the network traffic load balancing process transfers a defined user equipment from being connected to a source cell of a group of cells of the communication network to being connected to a target cell of the group of cells.

17. The non-transitory machine-readable medium of claim 16, wherein the operations further comprise:
prior to the determining of the graphical representation of the communication network, training a first model to a first defined confidence level, wherein the training of the first model comprises performing localized processing at a radio unit level of the communication network; and
based on information indicative of weighted values associated with the first model, training a second model to a second defined confidence level, wherein the training of the second model comprises performing pooled processing at a radio access network intelligence controller level of the communication network.

18. The non-transitory machine-readable medium of claim 17, wherein the weighted values are non-zero weights that represent respective connectivities between the group of radio units and the radio access network intelligent controller.

19. The non-transitory machine-readable medium of claim 18, wherein the training of the second model comprises training the second model to facilitate conformance with a network energy savings minimization criterion.

20. The non-transitory machine-readable medium of claim 17, wherein the first model and the second model are message passing graph neural network models.
